(19) United States
(12) Patent Application Publication
(10) Pub. No.: US 2025/0340094 A1
(43) Pub. Date: Nov. 6, 2025

(54) REGENERATIVE ENERGY SYSTEM USING A HYDRAULIC ACTUATOR AND A KINETIC ENERGY TRANSFER SYSTEM TO A GENERATOR

(71) Applicant: G.R.E.S. LLC, Sun Valley, CA (US)

(72) Inventor: Ashot Salvaryan, Sun Valley, CA (US)

(21) Appl. No.: 19/208,512

(22) Filed: May 14, 2025

Related U.S. Application Data
(63) Continuation-in-part of application No. 17/902,743, filed on Sep. 2, 2022, now Pat. No. 12,345,241.
(60) Provisional application No. 63/647,468, filed on May 14, 2024.

(51) Int. Cl. B60G 13/14

(52) U.S. Cl. CPC B60G 13/14; B60G 2202/24; B60G 2202/42; B60G 2202/442; B60G 2300/50; B60G 2300/60

(57) ABSTRACT

The present invention is a system and method for recovering the kinetic energy created by movement of a vehicle frame relative to a vehicle suspension to generate electrical energy that may be utilized on-the-fly or stored in order to provide power to an electric vehicle, wherein an embodiment for a regenerative energy system uses a hydraulic system coupled to the shock absorbers of a vehicle or trailer, wherein the captured kinetic energy is transferred to a plurality of gear assemblies to convert movement of the vehicle or trailer to rotary motion that is then amplified in rotational speed by a gear reduction system to cause rotational movement of a shaft of one or more generators in a single rotational direction to thereby generate electricity that may be utilized directly by electrical motors or stored in batteries or supercapacitors.

### BACKGROUND

Field of the Invention: This invention relates generally to power regeneration systems. More specifically, the invention pertains to a system for reclaiming kinetic energy that is generated by the movement of an object as it is traveling by wheels on a road, and even more specifically from the vibrations that are experienced by a vehicle suspension system. First, a hydraulic system is coupled to one or more shock absorbers of a vehicle or trailer. Vertical movements of the shock absorbers are captured by the hydraulic system and transferred to a plurality of gears. These gears are used to amplify and transform the vertical motions of the vehicle suspension system into rotational motions of a shaft that is used to drive an alternator or a generator to produce electricity that can be utilized by an electric vehicle.

Description of Related Art: The prior art includes various examples of kinetic energy recovery systems that are specifically designed as components of a vehicle, and which are capable of generating electrical energy that may also be used by a vehicle.

One example of the prior art teaches a piston type of pump that is mounted between a vehicle frame and the suspension. The pump charges a high-pressure accumulator for driving hydraulic motors, e.g., power windows, power seats, alternator, etc.

In another embodiment, electricity is generated directly by a conductor moving with respect to a magnetic field as a result of the up and down motions of a vehicle suspension system.

In another invention, an air compressor mounted between the vehicle frame and suspension compresses air for storage in a pressure tank and is used to power pneumatic devices.

Another document in the prior art teaches an energy regeneration device that is disposed within a chassis spring of a suspension system that transforms kinetic energy generated by elongation and compression of the chassis spring to electrical energy by the piezo electrical effect. A suspension device of a vehicle is provided with one or more links for connecting to a vehicle body which is supported using a chassis spring and a shock absorber, and it may modulate horizontal movement of a vehicle body and a wheel by modulating rigidity and flexibility.

The system described above includes a transforming body configured to be compressed or elongated by a chassis spring of the suspension system, and an electric generating member that is electrically connected and configured to be compressed or elongated with the transforming body.

The transforming body is disposed between coils of the chassis spring of the Suspension system. The electric generating members are aligned between adjacent pitches of the coils so that the electric generating members are compressed or elongated by relative movements of the coils.

The energy generation system also includes a rectifier that is electrically connected with the electric generating members through the connector and rectifies an electric current made by the electric generating members, where the electric generating member is a piezoelectric element.

What is apparent from the prior art is that there seem to be many different ways of capturing the kinetic energy of movement of a vehicle suspension system and transforming it into usable mechanical and/or electrical energy.

However, the prior art appears to suffer from various drawbacks including, but not limited to, not generating a significant amount of energy, not generating energy rapidly, and being too fragile to work consistently in the environment in which they operate because of operating conditions of the road.

Accordingly, it would be an advantage over the prior art to provide a durable method of converting mechanical or kinetic energy into electrical energy in sufficiently large quantities to provide significant benefits to an electric or partially electric vehicle. It would be a further advantage to create a two-step process, wherein a first step is to hydraulically convert linear motion to rotational motion, and a second step is to more efficiently convert the rotational motion to electrical energy.

It is useful to examine a previous version of the present invention in more detail to observe how it has been improved.

FIG. 1 is a block diagram of the components of a previous embodiment of the invention. As will be explained, the previous embodiment is able to capture the kinetic energy from both the upward and the downward motion of the vehicle suspension system 8.

In the block diagram view in FIG. 1, a rack and pinion assembly 10 may be coupled to the vehicle suspension system 8. The rack and pinion assembly 10 is then coupled to a linear motion to rotational movement conversion system 12 which is in turn coupled to a rotational movement amplification system 14. The rotational movement amplification system 14 is then coupled to an alternator or generator 16 for generating electricity. The combination of the rack and pinion assembly 10, the linear to rotational movement conversion system 12, the rotational movement amplification system 14, and the alternator 16 may be referred to as the regenerative energy system 18.

FIG. 2 is a perspective view of the previous embodiment of the present invention. FIG. 2 shows only a portion of a vehicle so that the elements of the previous embodiment are more easily visible. What is shown is the vehicle chassis or frame 20 that provides support for the wheels 22, the vehicle suspension system 24, and a passenger compartment (not shown) that rests upon the vehicle suspension system. In the case of an electric vehicle, the vehicle will also have one or more electric motors (not shown) and a battery (not shown) and may also include a supercapacitor (not shown).

While a relatively small frame 20 is shown for the vehicle, this is for illustration purposes only. Accordingly, the frame 20 may be lengthened or shortened and disposed in larger or smaller vehicles. Thus, any vehicle having a vehicle suspension system or is a vehicle that is caused to move up-and-down as it travels may utilize the previous embodiment of the invention. The vehicles that may utilize the previous embodiment of the invention may include, but should not be considered as limited to, a compact car, a mid-size car, a large sedan, a cross-over vehicle, a sport utility vehicle, a pickup truck, a van, a bus, a utility vehicle, a truck, and a semi-truck. This list should be considered only as a sample of the vehicles that may utilize the previous embodiment of the present invention and not a limiting factor.

While the frame 20, the wheels 22, and the vehicle suspension system 24 of the vehicle are shown in FIG. 2, also displayed are components of the previous embodiment of the invention. These elements include a plurality of rack and pinion systems, each comprised of a plurality of rack and pinion gear boxes 26 and linear transformation racks 28 (or linear transformation system). The previous embodiment is also comprised of a gear reduction system 30, and a double shaft alternator or generator 32 (only referred to as an “generator” hereinafter).

Subsequent drawings will illustrate the features of the previous embodiment in greater detail; however, it is noted that the double shaft generator 32 is being rotated by gear reduction systems 30 on both sides, hence the need for the double shaft on the alternator. Thus, a gear reduction system 30 is disposed on each side of the double shaft generator 32 to ideally keep the alternator rotating in an uninterrupted manner whenever the vehicle is moving.

Alternatively, the generator 32 may include a single shaft and may be coupled to only one gear reduction system 30.

Accordingly, the design of the previous embodiment is to create uninterrupted rotation of the double shaft of the generator 32 whenever the vehicle is traveling fast enough to cause up and down movement of the vehicle on the road. Uninterrupted rotation is desired because the shaft of the generator 32 needs to be turning in order to generate electricity. A typical alternator in a gas engine can generate electricity when the engine is idling and will rotate at around 800 rpm but will regularly rotate at 2400 rpm or higher. However, the generator 32 may rotate are far slower rpms to generate electricity. For example, electricity may be generated by the generator 32 with as little as 300 rpms.

However, it should also be understood that the generator 32 may periodically slow down or even stop when the vehicle is not moving fast enough to provide the needed movement of the vehicle suspension system.

The previous embodiment may use an induction motor/generator. Alternatively, a second embodiment of the invention may use a motor having a permanent magnet. It is noted that the generators 32 of the embodiments of the invention may generate electricity when rotating as little as 300 rpm.

The previous embodiment is designed with a reduction gear system 30 on each side of the generator 32 so that when the vehicle is traveling above 5 miles per hour, the double shaft of the generator 32 will rotate at a minimum of 1000 rpm.

It should be understood that these figures for rotation of the double shaft of the generator 32 are examples only, and that the shaft may rotate at lower or higher rpms and the generator 32 may still generate electricity to charge a battery or supercapacitor.

It is noted that either a generator or an alternator may be used in the previous embodiment of the invention. Each device has its advantages and disadvantages, and the device is selected that is best suited to the application. For example, while both generators and alternators convert mechanical energy into electrical energy, alternator brushes generally last longer than those of generators, and alternators can fit into smaller spaces than generators. In addition, while alternators only generate AC voltage, a generator can produce both AC and DC voltage. A single vehicle may include both alternators and generators, only alternators, or only generators depending on the operational needs of the vehicle.

The previous embodiment shown in FIG. 2 shows a rack and pinion gear box 26 at each corner of the frame 20. Using more than one rack and pinion gear box 26 in the vehicle enables more torque to be generated to thereby turn more than one generator 32 to generate electricity in the previous embodiment. Thus, while the previous embodiment shows a single generator 32, a plurality of generators 32 may be disposed in a single vehicle.

It is likely that a plurality of generators 32 operating in series may be used in a single vehicle in order to generate a typical 480 volts of an electric vehicle battery. For example, the generator of the previous embodiment may be capable of generating 48 volts and thus an increase in voltage is clearly necessary. This may be accomplished by a combination of adding generators and electronically increasing the voltage. Thus, there are devices or circuits such as voltage regulators and transformers that enable a smaller voltage to be increased to a greater voltage sufficient for charging a battery or a supercapacitor, as is known to those skilled in the art.

The output of the generator 32 may also be discussed in terms of watts. A typical generator 32 may generate 1000 to 2500 watts. Therefore, two generators 32 operating in series may thus typically generate anywhere from 2 to 5 kW. However, these numbers should be considered only as examples and that selection of specific generators 32 may vary these results.

A last feature of the previous embodiment shown in FIG. 2 is the point of contact between the rack and pinion gear box 26 and the frame 20 of the vehicle. Each of the rack and pinion gear boxes 26 includes a vertical rack gear bar 34 that may be in contact with a suspension plate 36 that is coupled to the suspension system 24. The movement of the suspension plate 36 causes the up-and-down movement of the vertical rack gear bar 34 of the rack and pinion gear box 26.

FIG. 3 is a perspective view of the previous embodiment shown in FIG. 2 but without the wheels 22. This figure more clearly illustrates the suspension plate 36 that is contact with the vertical rack gear bar 34 of the rack and pinion gear box 26.

FIG. 4A is a profile view of the frame 20 of the vehicle. The figure also illustrates the wheels 22, the suspension systems 24, the gear and pinion boxes 26, the linear transformation racks 28, the vertical rack gear bars 34, and the suspension plates 36.

While a connection between the linear transformation racks 28 and the vertical rack gear bars 34 is shown as being the suspension plate 36, it is noted that any mechanical system that transfers movements of the suspension system 24 to the gear and pinion boxes 26 may be used and should be considered to be within the scope of the previous embodiment.

FIG. 4B is a bottom view of the frame 20 of the vehicle. The figure also illustrates the tires 22, the linear transformation racks 28, the suspension plates 36, and a support plate 38 for the reduction gear system 30 (not shown) and the generator 32 (not shown) that are disposed on the other side.

FIG. 4B illustrates the relationship between the suspension plates 36 and the vertical rack gear bars 34. It is now useful to examine the details inside the rack and pinion boxes 26 from which the vertical rack gear bars 34 are extended.

FIG. 5 is a perspective view of the inside of the rack and pinion box 26. The rack and pinion box 26 converts the vertical up-and-down motion of the vehicle suspension system 24 to a back-and-forth horizontal motion. The vertical rack gear bar 34 includes a portion with gear teeth that make contact with (engage) a small pinion gear 40. The vertical motion of the vertical rack gear bar 34 causes the small pinion gear 40 to rotate in relatively small increments back and forth. A large pinion gear 42 is directly coupled to the small pinion gear 40.

It should be understood that while the rack and pinion box 26 of the previous embodiment shows the small pinion gear 40 and the large pinion gear 42, more gears could be provided to further amplify the movements of the vertical rack gear bar 34, and thus the utilization of the two gears 40, 42 should not be considered a limiting factor.

The larger diameter of the large pinion gear 42 magnifies the small movements of the small pinion gear 40. The large pinion gear 42 in turn engages the teeth of a top horizontal rack gear bar 44 and a bottom horizontal rack gear bar 46. The top horizontal rack gear bar 44 and the bottom horizontal rack gear bar 46 are thus caused to move back and forth in the direction of the arrows at the end of each horizontal rack gear bar 44, 46.

The greater diameter of the large pinion gear 42 is part of the overall system objective to magnify the small up-and-down vertical movements of the vehicle suspension system 24. The gear ratio between the large pinion gear 42 and the small pinion gear 40 may be modified as needed to achieve the desired rotation of the double shaft of the generator 32. In this illustration, the gear ratio is 1:2.5. If a third gear were added, the gear ratio may increase to 1:6.25, and so on.

After the rack and pinion box 26 has converted the vertical movements of the suspension system 24 to horizontal movements of the top horizontal rack gear bar 44 and the bottom horizontal rack gear bar 46, the next step is performed by the linear transformation rack 28. As shown in FIGS. 2 and 3, the rack and pinion gear box 26 is coupled to the linear transformation rack 28 by a top and a bottom rack gear bar 44, 46. More specifically, a coupling bar 98 is disposed between the top horizontal rack gear bar 44 and the bottom horizontal rack gear bar 46 of each of the rack and pinion gear boxes 26 and the top and bottom horizontal rack gear bars 44, 46 of the linear transformation rack 28.

### BRIEF SUMMARY

The present invention is a system and method for recovering the kinetic energy created by movement of a vehicle frame relative to a vehicle suspension to generate electrical energy that may be utilized on-the-fly or stored in order to provide power to an electric vehicle, wherein an embodiment for a regenerative energy system uses a hydraulic system coupled to the shock absorbers of a vehicle or trailer, wherein the captured kinetic energy is transferred to a plurality of gear assemblies to convert movement of the vehicle or trailer to rotary motion that is then amplified in rotational speed by a gear reduction system to cause rotational movement of a shaft of one or more generators in a single rotational direction to thereby generate electricity that may be utilized directly by electrical motors or stored in batteries or supercapacitors.

In a first aspect of the invention, it is an object of the present invention to provide a method and system of recovering the kinetic energy associated with the movement of a vehicle frame relative to the vehicle suspension to generate electrical energy that may be applied directly to an electrical motor or stored for later use.

In a second aspect of the invention, a plurality of hydraulic lines are coupled to shock absorbers on the suspension system of a vehicle or a trailer.

In a third aspect of the invention, the plurality of hydraulic lines are used to push hydraulic fluid to thereby cause a back-and-forth linear motion of at least one piston.

In a fourth aspect of the invention, linear motion of the piston is coupled to a system of gears to mechanically convert linear motion to rotational motion.

In a fifth aspect of the invention, the rotational motion may be directed to a generator or an alternator to thereby enable rotational motion to generate electrical energy that may be used at that moment, stored for future use, or both.

In a sixth aspect of the invention, the electrical energy generated by the embodiments of the invention may be stored so that it may be used by a vehicle that at least partially uses electrical motors to power the motion of the tires.

In a seventh aspect of the invention, the small up-and-down movements of the vehicle are magnified through the hydraulic system coupled to one or more gears in order to convert the small movements into the turning of gears that directly rotate a shaft of an alternator or generator.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of the previous embodiments of the invention.

FIG. 2 is a perspective view of previous embodiments of the present invention.

FIG. 3 is a perspective view of previous embodiments shown in FIG. 2 but without the wheels.

FIG. 4A is a profile view of the frame of the vehicle in previous embodiments.

FIG. 4B is a bottom view of the frame of the vehicle. In previous embodiments

FIG. 5 is a perspective view of the inside of the rack and pinion box in previous embodiments.

FIG. 6 is a block diagram of the components of the embodiments of the invention.

FIG. 7 is a block diagram that is provided as an example of the scalability of the first embodiment of the present invention.

FIG. 8 is a block diagram that is provided as an example of the scalability of the first embodiment of the present invention.

FIG. 9 is a block diagram that shows that the electrical energy generated by the regenerative energy system may be stored in a battery or a supercapacitor.

FIG. 10 is a diagram of the components of the first embodiment of the invention without the chassis of the vehicle.

FIG. 11 is a perspective view of one possible gear reduction box that is not enclosed, and a generator coupled to two different gear reduction systems.

FIG. 12 is a perspective view of a vehicle chassis, tire, partial vehicle suspension system and two hydraulic hoses that extend from a hydraulic fluid cylinder used in the vehicle suspension system.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

It is first useful to understand the source of kinetic energy of the embodiments of the invention. The source of kinetic energy is motion that is typically in an upward and downward direction that is constantly repeating. The motion may not be consistent or constant but is rather a series of random events that are dependent upon irregularities in the surface of a road being traveled upon by the vehicle. Everyone who travels by car is aware of the constant and typically small bounces of a vehicle caused by driving over an irregular driving surface. It is these motions that are harnessed to drive the shaft of an alternator or generator. Thus, the present invention is capable of continuously capturing energy from repetitive motions of a vehicle while moving.

In the embodiments of the present invention, kinetic energy is captured from the motion of wheels, wherein this motion is perpendicular to the roadway. A vehicle may be described as having a cabin for passengers and cargo, a frame on which the cabin rests, a plurality of wheels, and a suspension system that is disposed between the wheels and the frame that cushions the movement of the cabin as the wheels travel on the road.

A vehicle's suspension system may be a protective lattice of shock-absorbing components such as springs and shock absorbers. A vehicle's suspension system helps ensure that a drive is safe and smooth by absorbing the energy from various road bumps and other kinetic impacts on the wheels. Furthermore, it helps the wheels stay in contact with the road by increasing tire friction.

While the embodiments of the invention are focused on capturing energy from the motion of a vehicle, it should be understood that the principles apply to capturing energy from any source of repetitive motion. There is also no limit on the type of motion that may be converted and is therefore not limited to an up-and-down motion.

A practical application of the first embodiment invention is directed to the movement of a vehicle, or a trailer being pulled by a vehicle. The function of a vehicle suspension is to maximize the friction between tires and a road surface, to provide steering stability with good handling, and to ensure the comfort of the passengers. If a road were perfectly flat with no irregularities, suspensions would not be necessary. However, roads are far from flat. Even freshly paved highways have imperfections that can interact with the wheels of a vehicle. These imperfections apply forces to the wheels. All forces have both magnitude and direction. Thus, a bump in the road causes the wheel to move up and down perpendicular to the road surface and the direction of travel. The magnitude of the force depends on whether the wheel is striking a large bump or a small one and the velocity of the wheel. Regardless, the wheel experiences a vertical acceleration as it passes over any roadway imperfection.

Without an intervening structure, all of the wheel's vertical energy is transferred to the vehicle frame which moves in the same direction. In such a situation, the wheels may even lose contact with the road. Then, under the downward force of gravity, the wheels may slam back into the road surface.

Road isolation refers to the vehicle's ability to absorb or isolate road shock from the passenger compartment, thereby allowing the vehicle body to ride undisturbed while traveling over rough roads. The suspension system absorbs energy from road bumps and dissipates the energy without causing undue oscillation in the vehicle.

The suspension system of a vehicle is part of the chassis, which includes all of the important systems located beneath the vehicle's body. These systems include the frame, the suspension system, the steering system, and the wheels. The frame supports the vehicle's motors and body which are, in turn, supported by the vehicle suspension system. The vehicle suspension system supports weight, absorbs and dampens shock, and helps maintain tire contact with the roadway. The steering system enables the driver to guide and direct the vehicle. The tires and wheels make vehicle motion possible by way of friction with the road. Whether loosely sprung or tightly sprung, the suspension system of any vehicle is constantly moving relative to the frame.

Unless a dampening structure is present, a vehicle spring will extend and release the energy it absorbs from a bump at an uncontrolled rate. The spring will continue to bounce at its natural frequency until all of the energy originally put into it is dissipated. A suspension system built on springs alone would make for an extremely bouncy ride and, depending on the terrain and speed, an uncontrollable vehicle. The shock absorber dissipates unwanted spring motion through a process known as dampening. Shock absorbers slow down and reduce the magnitude of vibratory motions by turning the kinetic energy of suspension movement into heat energy that can be dissipated through hydraulic fluid.

The regenerative energy system of the present invention generates useful energy from the up-and-down motion of a vehicle suspension system caused by roadway irregularities as the vehicle travels down the road.

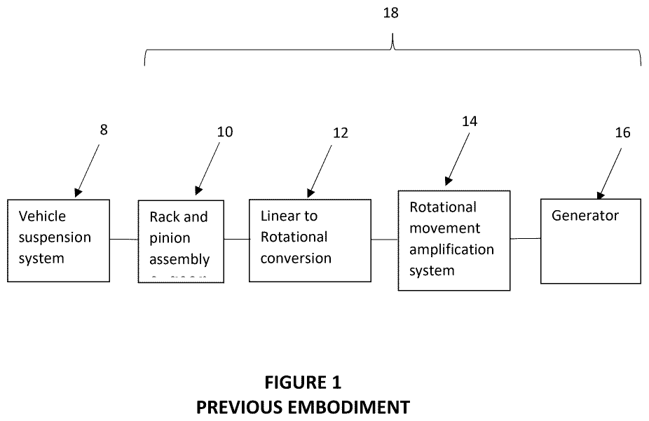

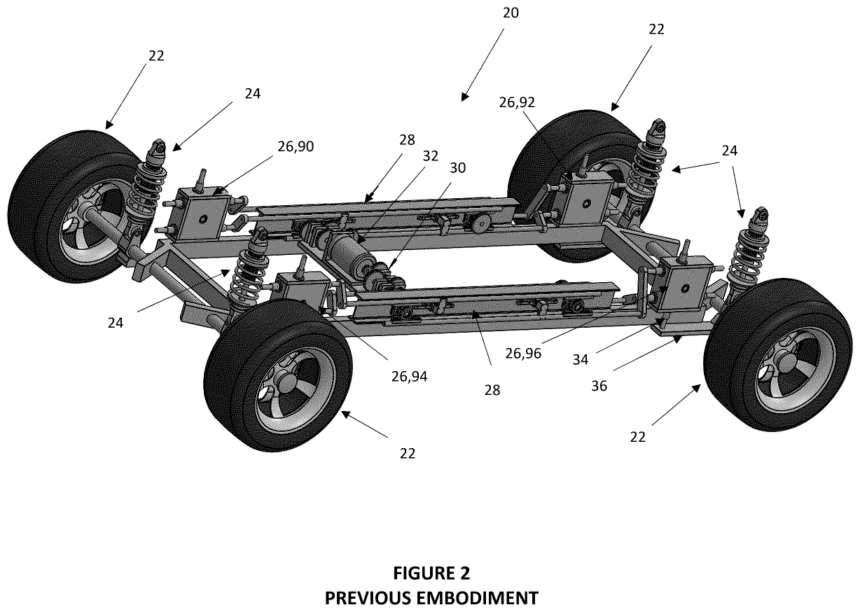

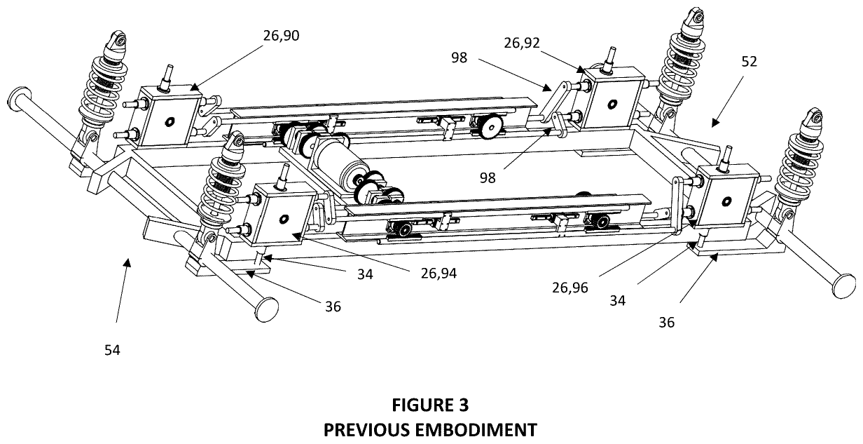

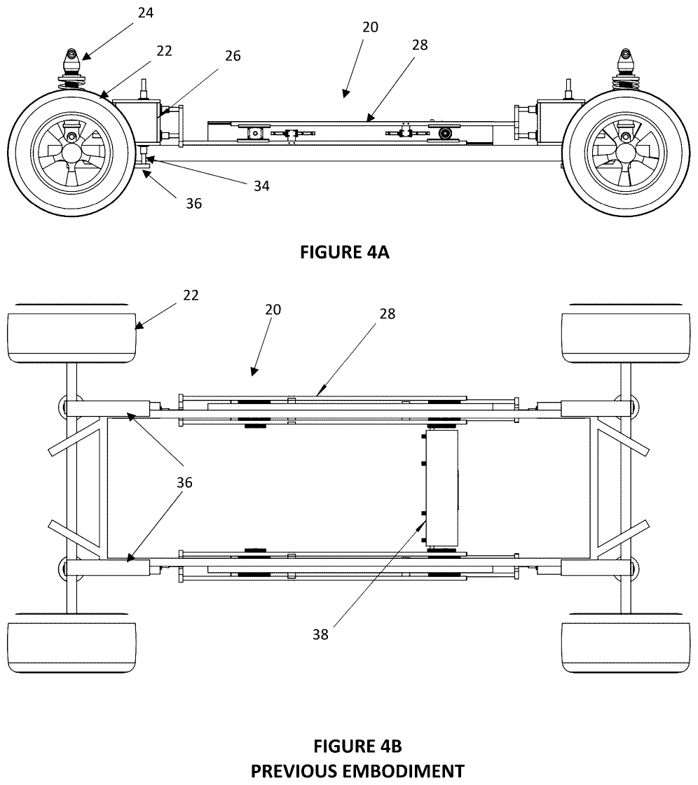

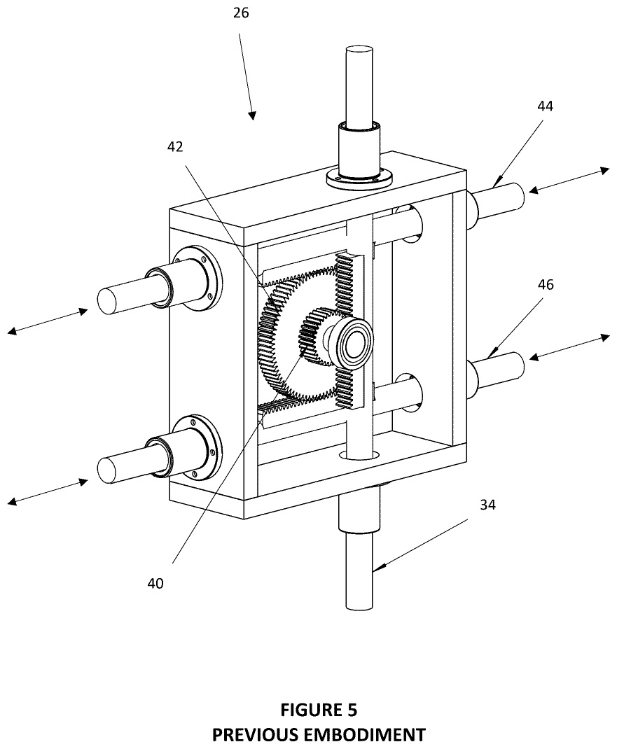

In the previous embodiment shown in FIG. 1 through 5, it was shown that a rack and pinion system 10 was used to convert the movement of the vehicle suspension system 8 to electrical energy. However, in this improved version of the invention, the rack and pinion system 10 is replaced with a more robust hydraulic system as will be shown.

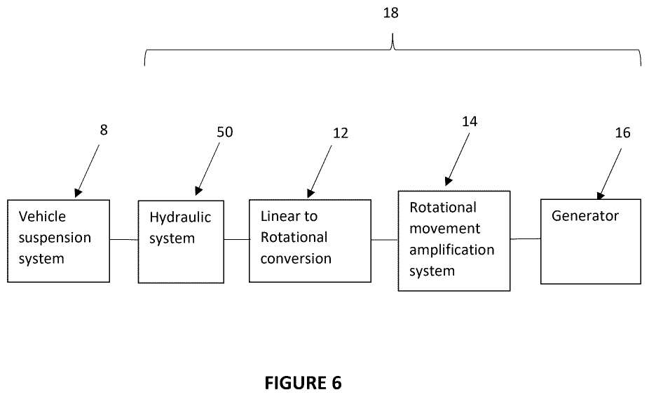

FIG. 6 is a block diagram of the components of a first embodiment of the present invention. As will be explained, the first embodiment is able to capture the kinetic energy from both the upward and the downward motion of the vehicle suspension system 8.

In the block diagram view in FIG. 6, a hydraulic system 50 may be coupled to the vehicle suspension system 8. The hydraulic system 10 is then coupled to a linear motion to rotational movement conversion system 12 which is in turn coupled to a rotational movement amplification system 14. The rotational movement amplification system 14 is then coupled to an alternator or generator 16 for generating electricity. The combination of the hydraulic system 10, the linear to rotational movement conversion system 12, the rotational movement amplification system 14, and the alternator 16 may be referred to as the regenerative energy system 18.

The hydraulic system 10 is utilized to convert up-and-down linear motion to horizontal linear motion, and then horizontal linear motion is converted to rotational motion using the linear to rotational movement conversion system 12. The rotational movement amplification system 14 is then utilized to amplify the rotational motion to thereby generate electricity using the generator 16. While the first embodiment shows that the conversion of linear motion to rotational motion and then the amplification of the rotational motion is performed by separate components, it should be understood that these functions may also be combined in a single step or device. However, the first embodiment uses the hydraulic system 10 to transfer linear motion to a location in the vehicle where it can be converted to rotational motion and finally coupled to a generator 16 to thereby generate electricity. The electricity is then either stored in a battery or capacitor or delivered directly to an electrical motor.

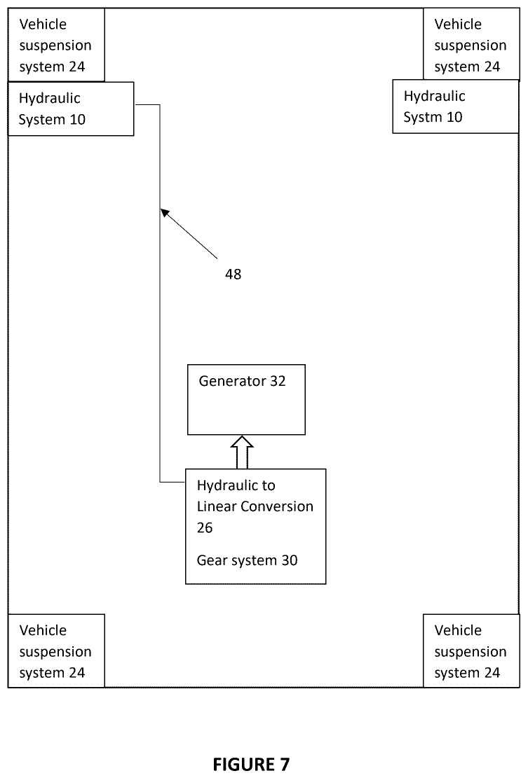

FIG. 7 is a block diagram that is provided as an example of the scalability of the present invention. Thus, in a first embodiment, a hydraulic system 10 may be disposed adjacent to a vehicle suspension system 24, followed by a hydraulic hose 48 to a hydraulic to linear conversion system 26 and gear system 30, and finally to a generator 32.

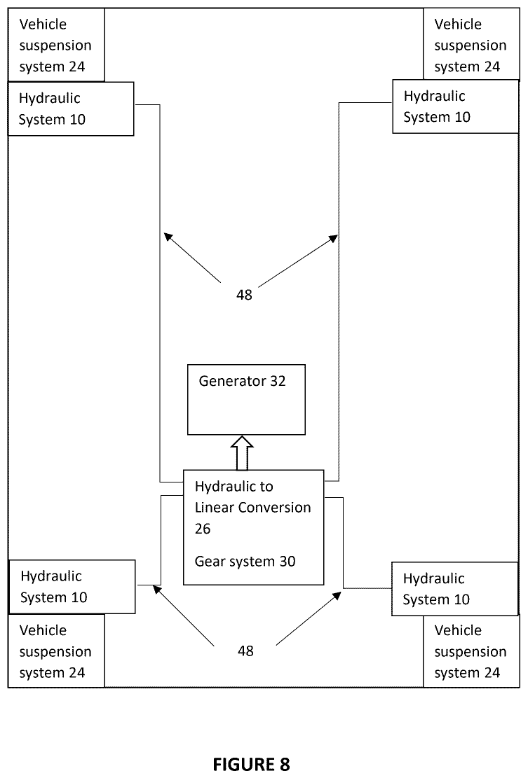

Similarly, the embodiment shown in FIG. 7 may be modified to include more components to achieve the desired electrical output of the regeneration energy system 18. For example, the hydraulic system 10 may be disposed adjacent to each vehicle suspension system 24, followed by the hydraulic hose 48 to the hydraulic to linear conversion system 26 and gear system 30, and finally to the generator 32 as shown in FIG. 8.

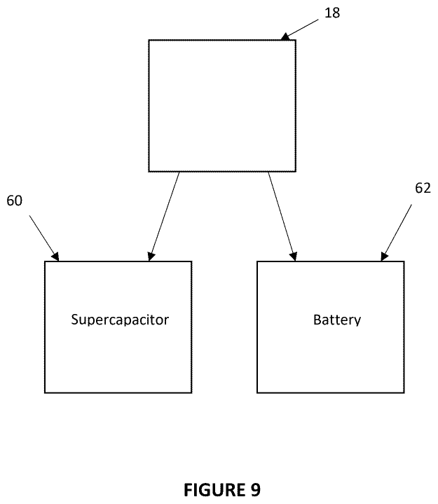

FIG. 9 is used to illustrate that in another aspect of the embodiments of the invention, a specific utilization of the electrical energy that is being generated by the embodiments of the invention may be shown. Specifically, it is another aspect of the invention that the electrical energy generated by the regenerative energy system 18 may be stored in a supercapacitor 60 instead of in a battery 62 of the vehicle. Alternatively, the electrical energy may be directed only to the battery 62. In another alternative embodiment, the electrical energy may be directed to both the supercapacitor 60 and the battery 62.

The energy stored in the supercapacitor 60 may be accessed when additional power is required such as when a vehicle is trying to ascend a hill. Accordingly, it may be recommended that the electrical energy stored in the supercapacitor 60 be accessed when trying to climb a hill because the supercapacitor may be drained more rapidly than energy from the battery 62 and may thus assist a vehicle to maintain speed or to even accelerate up a hill. In other words, the supercapacitor 60 may be capable of a faster rate of discharge to a motor as compared to the battery 62 and thus may be called upon for bursts of energy when it is needed instead of a steady flow.

Another aspect of the embodiments of the invention that should be understood regarding the generator 32 of the regenerative energy system 18. While a stock alternator may be used, the generator 32 may also be a customized part that generates a greater amount of voltage than standard vehicle generators. Furthermore, the generator 32 may be replaced with an alternator, a stepper motor, or a brushless motor, or any other suitable electrical device or motor. What is important is that the function of the generator 32 be provided in the regenerative energy system 18.

While the embodiments of the invention above are directed to a regenerative energy system 18 that is coupled to a vehicle suspension system, it should be understood that there are other sources of movement that may be utilized to generate electricity using a similar regenerative energy system.

The embodiments above are directed to using a regenerative energy system to generate electricity from the movements of a vehicle while traveling. While vehicles with four wheels have been suggested as benefiting from the invention, it should be understood that the present invention may also be implemented on a vehicle with more than four or less than four wheels. Furthermore, the present invention is not limited to vehicles with wheels or with motors.

For example, the movement of trailers on a road may also be used to generate electricity. Consider semi-trucks and the trailers that they haul. These trailers may also have suspension systems and experience all of the movements of the road. Thus, the embodiments of the present invention may be implemented in trailers. Electricity that is generated may be stored in batteries or supercapacitors in the trailers, or the electricity may be transferred via power cables to the battery or supercapacitor of an electrically powered semi-truck. It is envisioned that an electrically powered semi-truck could substantially extend its driving range if the semi-truck and its trailer or trailers were all equipped with the embodiments of the invention.

Furthermore, an electrically powered semi-truck or larger vehicle such as a bus may have a problem driving on hills because of the increased power requirements. The embodiments of the present invention may be used to charge supercapacitors as well as batteries. A supercapacitor may be capable of discharging electricity at a faster rate than a battery. Thus, a semi-truck hauling one or more trailers may be able to draw on large amounts of electricity from a supercapacitor in order to maintain speed or even accelerate up a hill.

In summary, a regenerative energy system is configured to capture energy from a moving vehicle, said system comprising a vehicle suspension system that dampens movements of the moving vehicle as it travels, hydraulic system that is coupled to the suspension system, wherein the hydraulic system converts vertical motion of the vehicle suspension system to horizontal motion, a linear transformation system coupled to the hydraulic system, wherein the linear transformation system converts the horizontal motion of the hydraulic system to rotational motion, a gear reduction system coupled to the linear transformation system, wherein the gear reduction system receives the rotational motion of the linear transformation system and amplifies the rotational motion, and a single shaft alternator coupled to the gear reduction system, wherein the alternator receives the amplified rotational motion and generates electricity therefrom.

Similarly, a method for generating electricity from a moving vehicle in a regenerative energy system is a method comprising the steps of 1) providing a vehicle suspension system that dampens movements of the moving vehicle as it travels, 2) providing a hydraulic system that is coupled to the suspension system, 3) converting the vertical motion of the vehicle suspension system to linear motion using the hydraulic system, 4) converting the linear motion of the hydraulic system to rotational motion using the linear transformation system, 5) providing a gear reduction system coupled to the linear transformation system, 6) amplifying the rotational motion receiving from the linear transformation system using the gear reduction system, 7) providing a single shaft alternator coupled to the gear reduction system, and 9) generating electricity from the alternator as the gear reduction system rotates the alternator.

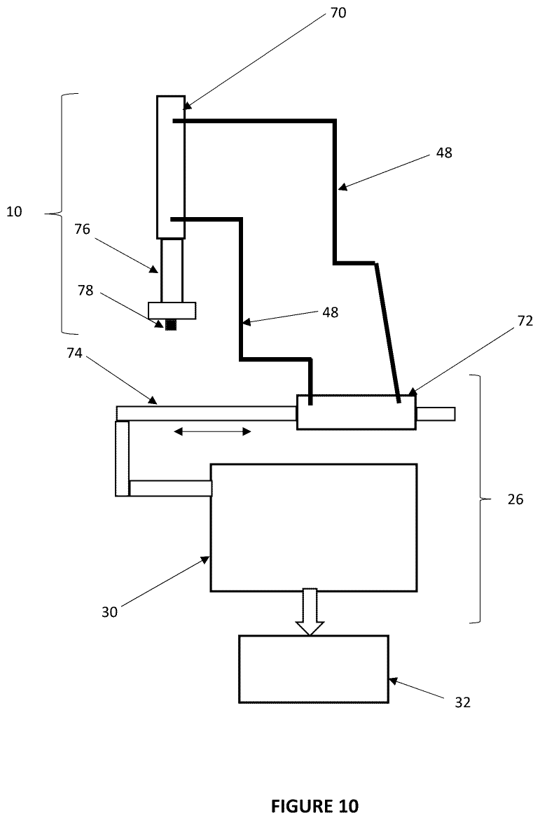

FIG. 10 is a view of key components of the first embodiment of the invention that are changed from the previous embodiments. The rack and pinion gear box and linear transformation rack of the previous embodiment are now replaced with more robust hydraulic components.

Specifically, a hydraulic fluid cylinder 70 of the vehicle suspension system 24 is shown. The orientation of the hydraulic fluid cylinder 70 is not critical to the invention. What is important is that there are two hydraulic hoses 48 attached to the hydraulic fluid cylinder 70 at a first end and a second end. A spring or coil 76 is wrapped around a shaft 78 that goes into the hydraulic fluid cylinder 70. As the shaft 78 travels up and down or in and out of the hydraulic fluid cylinder 70, the hydraulic fluid flows through the hydraulic hoses 48.

The two hydraulic hoses 48 are attached to a receiving hydraulic conversion cylinder 72. As hydraulic fluid inside the hydraulic fluid cylinder 70 moves in and out when the vehicle suspension system 24 is operating, the hydraulic fluid is moving in and out of the receiving hydraulic conversion cylinder 72. Hydraulic fluid movement causes a lever arm 74 to move back and forth within the receiving hydraulic conversion cylinder 72.

The lever arm 74 is thus moving in and out of the gear box 30 in a linear motion. This linear motion is converted into rotational motion within the gear box 30 in a manner that is known to those skilled in the art. The gear box 30 functions not only to convert linear to rotational motion but also functions as a gear reduction system that is attached to the generator 32 and thereby generating electricity.

The gear box 30 may include a plurality of lever arms 74 that are coupled to other receiving hydraulic conversion cylinders 72 which are in turn coupled to other hydraulic fluid cylinders 70. For example, in a vehicle with four independent vehicle suspension systems 24, there are may be four lever arms 74 that are connected to gear reductions systems within the gear box 30.

It is noted that a force may be applied to the lever arm 74 when the hydraulic fluid is flowing in one direction. When the hydraulic fluid flows in the opposite direction, no force is applied to the lever arm 74 and it is free to return to an initial position that is ready to apply force to the gear box 30. This ability to apply a force to the lever arm 74 when hydraulic fluid is flowing in only one direction may be made possible through the use of a one-way bearing.

The one-way bearing may be disposed within the hydraulic conversion cylinder 72.

It should be understood that all of the vehicle suspension systems 24 are operating independently of each other. Therefore, hydraulic fluid may be flowing back and forth between the hydraulic fluid cylinders 70 and the receiving hydraulic conversion cylinders 72 at different times. This means that the lever arms 74 will be moving back and forth in and out of the gear box 30 at different times. None of that independent motion will interfere with the operation of any other lever arm 74.

The motions of the lever arms 74 may be relatively small but even one hydraulic fluid cylinder 70 may cause its corresponding lever arm 74 to move, which causes the corresponding reduction gears in the gear box 30 to rotate which causes a shaft in the generator 34 to spin which thereby generates electricity.

When the hydraulic fluid in all four of the hydraulic fluid cylinders 70 are in slight motion, then this enables the gear box 30 to have many sources of linear motion being translated to rotational motion and thereby contribute to rotating the shaft of the generator 34.

Experimentation has shown that, on average, several kilowatts may be generated by driving at a relatively slow speed on city streets. If this motion is magnified by faster speeds and heavier vehicles, the number of kilowatts being generated may be substantial, and certainly enough to charge a battery or supercapacitor.

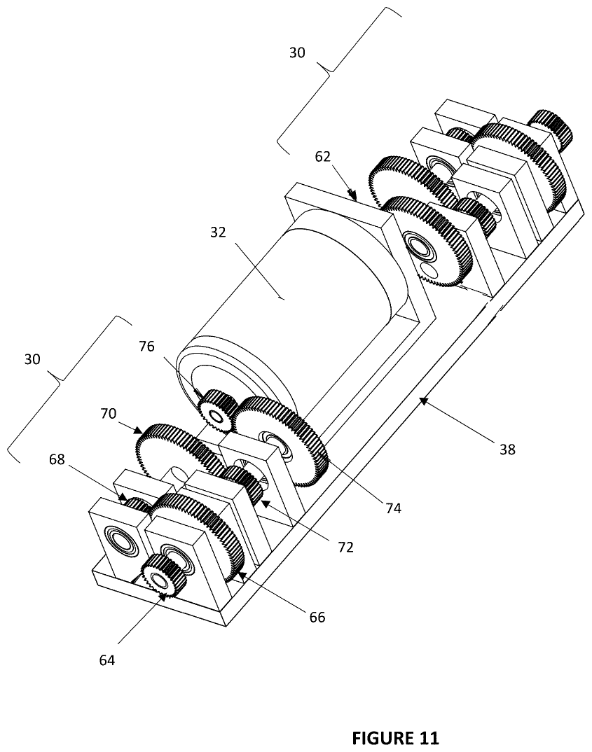

FIG. 11 is a perspective view of one possible implementation of the gear reduction system 30. The total number of gears may be modified because the system is scalable. However, FIG. 11 is a perspective view of a single generator 32 disposed on a support plate. The gear reduction system 30 on one side of the generator 32 is duplicated on the other side of the generator. Thus, in this first embodiment, the generator 32 is being driven on both sides because it has a double shaft. The generator 32 is shown having a mounting plate to stabilize the generator on the support plate.

Before describing the operation of the gear reduction system 30, it is noted that the function of the gear reduction system is to decrease the speed of rotation received from the output gear while increasing the torque.

The lever arm 74 will make contact with a first small input gear 64 of the gear reduction system 30. The small input gear 64 is coupled coaxially by a short drive shaft to a larger output gear 66. The larger output 66 gear makes contact with or engages a smaller input gear 68. The smaller input gear 68 is coupled coaxially by a short drive shaft to a larger output gear 70. The larger output gear 70 makes contact with or engages a smaller input gear 72. The smaller input gear 72 is coupled coaxially by a short drive shaft to a larger output gear 74 having a one-way bearing (not shown). Finally, the larger output gear 74 makes contact with or engages an input gear 76 on the generator 32. The use of the one-way bearings ensures that the gear reduction system 30 is only rotating the generator 32 in one direction.

The series of smaller input gears 64, 68, 72, and larger output gears 66, 70, 74, repeatedly use a gear ratio to decrease the speed of rotation until reaching the input gear 76 on the alternator. It is important to recognize that the number of smaller input gears and larger output gears may be selected in order to achieve the desired speed of rotation of the final large output gear 74. As stated earlier, this speed of rotation is carefully balanced against the increase in torque. The torque on the reductions gears 30 must be sufficient to enable the generator 32 to rotate and thereby generate electricity.

The exact gear ratio between each of the smaller input gears 64, 68, 72 and the corresponding larger output gear 66, 70, 74 may be adjusted as needed in order to obtain the desired speed of rotation and torque. In this first embodiment, the gear ratio from small gear to large gear has been selected to be 1:2.5. However, it should be understood that the gear ratio is only an example and may be modified as needed without affecting the scope of the claims.

It should also be understood that while there are three sets of smaller and larger gear pairs in each of the gear reduction systems 30, this number of gear pairs may also be modified without changing the function of the gear reduction systems.

One observation is that the various gears of the first embodiment have a surprising amount of inertia once the system is operating and generating electricity. This momentum enables the system to continue to rotate the generator 32 even when the vehicle travels on smooth segments of the road and the vehicle slows down.

A final observation that is useful for the first embodiment is that while spur gears may be used in the implementation of the first embodiment that is shown in the figures, one or more gears may be replaced with a different type of gear. For example, planetary gears may be used to replace some or all of the spur gears of the regenerative energy system 18. The embodiments may also use a mixture of spur and planetary gears.

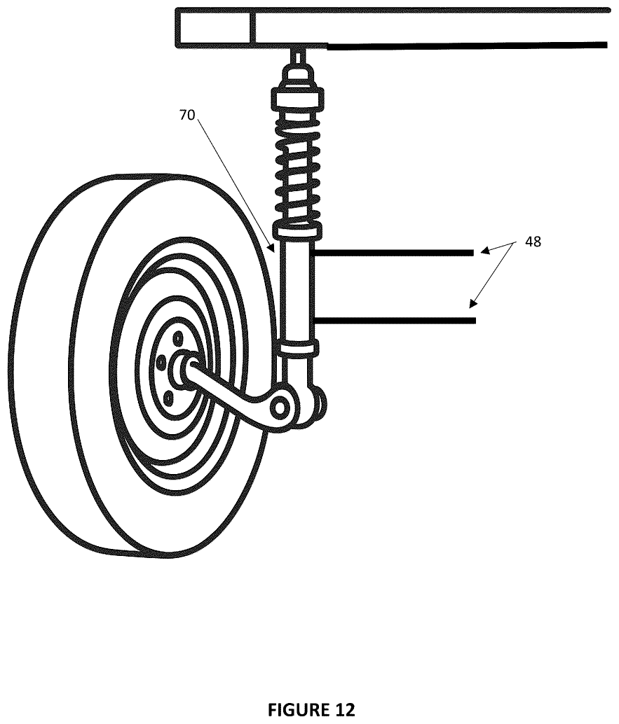

FIG. 12 is a close-up view showing that the first embodiment uses a hydraulic fluid cylinder 70 on a vehicle suspension system 24. The hydraulic fluid inside the hydraulic fluid cylinder 70 is flushed in and out through the two hydraulic hoses 48 as the vehicle travels and the vehicle suspension system 24 moves up and down.

In summary, the regenerative energy system is configured to capture energy from a moving vehicle, said system comprising a vehicle suspension system that dampens movements of the moving vehicle as it travels, a hydraulic fluid cylinder that is coupled to the vehicle suspension system, wherein the hydraulic fluid cylinder enables hydraulic fluid to flow in and out is response to movement of the vehicle suspension system, a hydraulic fluid receiving cylinder for receiving the hydraulic fluid from the hydraulic fluid cylinder, a lever arm that passes through the hydraulic fluid receiving cylinder and moves back and forth therethrough as the hydraulic fluid moves in and out and thereby converting motion of the hydraulic fluid to linear motion of the lever arm, a gear reduction system coupled to the lever arm for converting the linear motion of the lever arm to rotational motion, wherein the gear reduction system also increases torque of the lever arm and a generator coupled to the gear reduction system, wherein the generator receives the rotational motion of the gear reduction system and generates electricity therefrom.

The first embodiment also describes a method of generating electricity that may use different hardware configurations to achieve the same results.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A regenerative energy system configured to capture energy from a moving vehicle, said system comprising:
a vehicle suspension system that dampens movements of the moving vehicle as it travels;
a hydraulic fluid cylinder that is coupled to the vehicle suspension system, wherein the hydraulic fluid cylinder enables hydraulic fluid to flow in and out is response to movement of the vehicle suspension system;
a hydraulic fluid receiving cylinder for receiving the hydraulic fluid from the hydraulic fluid cylinder;
a lever arm that passes through the hydraulic fluid receiving cylinder and moves back and forth therethrough as the hydraulic fluid moves in and out and thereby converting motion of the hydraulic fluid to linear motion of the lever arm;
a gear reduction system coupled to the lever arm for converting the linear motion of the lever arm to rotational motion, wherein the gear reduction system also increases torque of the lever arm; and
a generator coupled to the gear reduction system, wherein the generator receives the rotational motion of the gear reduction system and generates electricity therefrom.

2. The regenerative energy system as defined in claim 1 wherein the system is further comprised of a battery that is charged by the generator.

3. The regenerative energy system as defined in claim 1 wherein the system is further comprised of a supercapacitor that is charged by the generator.

4. The regenerative energy system as defined in claim 1 wherein the system is further comprised of a plurality of vehicle suspension system, a plurality of hydraulic fluid cylinders, a plurality of hydraulic fluid receiving cylinders, a plurality of lever arms, and a plurality of gear reduction systems.
